(19) United States
(12) Patent Application Publication
(10) Pub. No.: US 2018/0130329 A1
(43) Pub. Date: May 10, 2018

(54) AUTOMATED MATERIAL SAFETY DATA MANAGEMENT

(71) Applicant: Energy Control Technologies, Inc., Davie, FL (US)

(72) Inventors: Matt Horton, St. Petersburg, FL (US); Richard Combs, Plantation, FL (US)

(21) Appl. No.: 15/344,570

(22) Filed: Nov. 6, 2016

(51) Int. Cl. G08B 21/18; H04W 4/12; G08B 25/10

(52) U.S. Cl. CPC G08B 21/182; G08B 25/10; H04W 4/12

(57) ABSTRACT

An automated material safety data management method includes creating in memory of an environmental control data processing system a listing of different materials stored in a geographic location managed by the environmental control data processing system. The method also includes querying a data store of safety data sheets and receiving in response to the querying different safety data sheets, each corresponding to a different one of the materials and parsing each of the different safety data sheets to identify one or more environmental limits specified in one or more of the different safety data sheets. The method yet further includes monitoring one or more sensors disposed in the geographic location. Finally, the method includes responding to an environmental condition sensed by one of the monitored sensors that exceeds one or more of the environmental limits by transmitting a notification to an operator of the environmental control data processing system.

### BACKGROUND OF THE INVENTION

### Field of the Invention

The present invention relates to material safety and more particularly to management of stored materials in accordance with known material safety data.

### Description of the Related Art

Modern governmental regulations require that manufacturers, distributors, and importers of materials including gases, solids, chemicals and organic compounds, provide for each material provided downstream to another party, a “safety data sheet”, also known as a material safety data sheet or MSDS. The purpose of a safety data sheet is to communicate information for a provided material regarding hazards associated with the material. The distinction between a “safety data sheet” also known as an SDS, and an MSDS, is that the SDS must be presented in a consistent user-friendly, multi-section format. The SDS, the MSDS, includes information such as the properties of a corresponding material, the physical, health, and environmental health hazards associated with the corresponding material, protective measures to be implemented to avoid the noted hazards and safety precautions for handling, storing, and transporting the corresponding material.

The first several sections of the SDS contains general information about the corresponding material, including the identification of the material, hazards associated with the material, the composition of the material, safe handling practices of the material, and emergency control measures such as fire fighting with respect to the material. The information in the first several sections of the SDS is intended to be helpful to those needing rapid access to the information. The remaining sections of the SDS contain other technical and scientific information, such as physical and material properties, stability and reactivity information, toxicological information, exposure control information, and other information including the date of preparation or last revision.

Traditionally, the production and management of the SDS has been a manually intensive process in which an individual completes a template form using a conventional word processor. Recent advances in SDS management however, include some automation of the SDS generation and distribution process. However, there exists little more automation of the SDS lifecycle beyond the automated creation and management of the SDS. Consequently, the utility of each SDS with respect to a corresponding material remains captive to the manual review and management of each SDS by an individual who may or may not maintain awareness of the content of each SDS and any hazards that may arise in consequence of changes in environment surrounding the material.

### BRIEF SUMMARY OF THE INVENTION

Embodiments of the present invention address deficiencies of the art in respect to SDS processing and provide a novel and non-obvious method, system and computer program product for automated material safety data management. In an embodiment of the invention, an automated material safety data management method includes creating in memory of an environmental control data processing system a listing of different materials stored in a geographic location managed by the environmental control data processing system. The method also includes querying a data store of safety data sheets and receiving in response to the querying different safety data sheets, each corresponding to a different one of the materials and parsing each of the different safety data sheets to identify one or more environmental limits specified in one or more of the different safety data sheets. The method yet further includes monitoring one or more sensors disposed in the geographic location. Finally, the method includes responding to an environmental condition sensed by one of the monitored sensors that exceeds one or more of the environmental limits by transmitting a notification to an operator of the environmental control data processing system, for example, wirelessly over the Internet to a mobile computing device of the operator.

In one aspect of the embodiment, the data store of safety data sheets is disposed remotely from the environmental control data processing system and accessed by the environmental control data processing system from over a computer communications network. In another aspect of the embodiment, responding to an environmental condition sensed by one of the monitored sensors that exceeds one or more of the environmental limits includes first associating in memory of the environmental control data processing system selected ones of the safety data sheets with a corresponding one of the sensors. Thereafter, an environmental condition is sensed by the corresponding one of the sensors and it is determined if a corresponding safety data sheet is associated with the corresponding one of the sensors. If so, the identified environmental limit is compared to the sensed environmental condition, and if the identified environmental limit exceeds one or more of the environmental limits, a notification is transmitted to an operator of the environmental control data processing system.

In another embodiment of the invention, an environmental control data processing system is provided. The system includes a host computing system with at least one computer with memory and at least one processor. The system also includes a multiplicity of sensors disposed about a geographic location and a monitor monitoring environmental conditions in the geographic location by way of the sensors. Finally, the system includes an automated material safety data management module. The module includes program code executing in the memory of the host computing system. The program code when executing creates in the memory a listing of different materials stored in the geographic location, queries a data store of safety data sheets and receives in response to the querying different safety data sheets, each corresponding to a different one of the materials, parses each of the different safety data sheets to identify one or more environmental limits specified in one or more of the different safety data sheets and responds to an environmental condition sensed by one of the monitored sensors that exceeds one or more of the environmental limits by transmitting a notification to an operator of the environmental control data processing system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated material safety data management;

FIG. 2 is a schematic illustration of a data processing system configured for automated material safety data management; and,

FIG. 3 is a flow chart illustrating a process for automated material safety data management.

### DETAILED DESCRIPTION OF THE INVENTION

Embodiments of the invention provide for automated material safety data management. In accordance with an embodiment of the invention, a material is placed in a geographic location instrumented with one or more sensors and managed by an environmental control data processing system. The sensors sense environmental conditions in the geographic location, such as temperature or humidity. An SDS for the material is located in a data repository and data in the SDS including environmental limits is identified in the environmental control data processing system. Thereafter, the environmental control data processing system monitors the sensors at a particular facility and if environmental conditions sensed by the sensors exceed the environmental conditions of the SDS, the environmental control data processing system transmits a notification to one or more site operators at the facility of the environmental control data processing system. In this way, the SDS provides continued utility not dependent upon the manual observations of an end user.

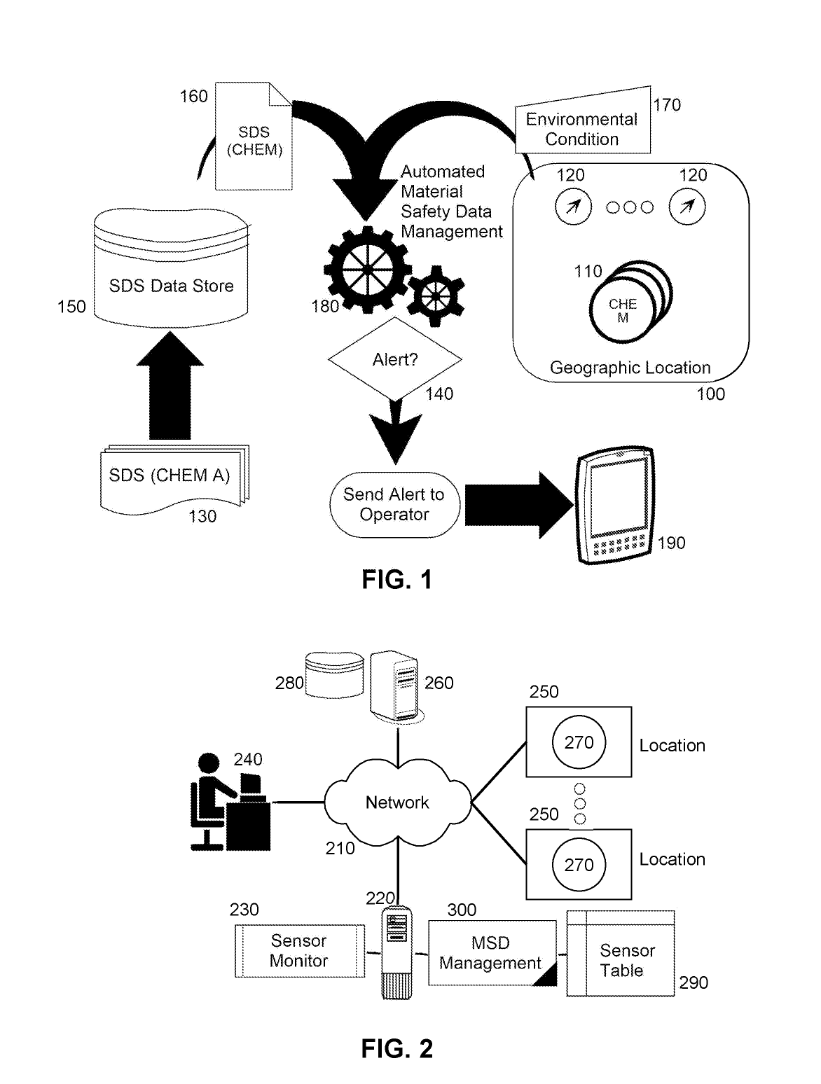

In further illustration, FIG. 1 pictorially shows a process for automated material safety data management. As shown in FIG. 1, one or more materials 110 are placed in a geographic location 100 such as a building, warehouse or storage yard. Different SDSs 130 are stored in an SDS data store 150 for the one or more of the materials 110 present in the geographic location 100. Initially, each of the SDSs 130 is presented to an operator of automated material safety data management logic 180 monitoring safety conditions in the geographic location 100. The operator then records an acknowledgment that the operator has reviewed each of the SDSs 130 in connection with corresponding ones of the materials 110.

One or more sensors 120 instrument the geographic location 110 including time, temperature and humidity sensors, by way of example. The sensors 120 then report environmental conditions 170 to automated material safety data management logic 180. In response to receiving a report of environmental conditions 170 in the geographic location 100, the automated material safety data management logic 180 determines if one or more SDSs 130 are stored in an SDS data store 150 for the one or more materials 110 present in the geographic location 100.

If one or more SDSs 130 are stored in an SDS data store 150 for the one or more materials 110 present in the geographic location 100, the automated material safety data management logic 180 retrieves an SDS 160 for a corresponding one of the materials 110 and parses the SDS 160 to identify one or more environmental limits specified in the SDS 160. The automated material safety data management logic 180 then compares the identified environmental limits to the environmental condition 170 to determine if an alert 140 is warranted for the environmental limits having been exceeded by the environmental condition 170. If so, the automated material safety data management logic 180 transmits the alert to the mobile device 190 of an operator of the automated material safety data management logic 180. As well, the operator is then required to acknowledge receipt of the alert which acknowledgment is stored in connection with the corresponding one of the materials 110.

The process described in connection with FIG. 1 may be implemented in a data processing system. In yet further illustration, FIG. 2 schematically shows a data processing system configured for automated material safety data management. The system includes a host computing system 220 with one or more computers, each with memory and at least one processor. The host computing system 220 is accessed by an operator 240 from over a computer communications network 210 and is coupled to a remote server 260 with coupled data store 280 in which a multiplicity of SDSs are stored for different corresponding materials. The host computing system 220 additionally coupled to a multiplicity of different geographic locations 250, each of which store at least one material 270.

The host computing system 220 hosts the operation of a sensor monitor 230 and a material safety data management module 300. The sensor monitor 230 monitors environmental conditions in each the locations 250 as reported by corresponding sensors disposed in the locations 250, such as time, temperature, pressure and humidity. The material safety data management module 300 includes program code that when executes in the memory of the host computing system 220 receives an indication from the sensor monitor 230 of an environmental condition in one of the locations 250. The program code of the material safety data management module 300 then consults a sensor table 290 to determine if the sensor providing the environmental condition is associated with material safety data management.

If so, the program code of the material safety data management module 300 determines a listing of materials 270 present in the one of the locations 250 and queries the server 260 to retrieve a corresponding SDS from the data store 280 for each of the materials 270 in the listing. The program code of the material safety data management module 300 then parses each SDS to identify different environmental limits to be compared to the environmental condition, such as a time limit, e.g. a shelf life of a corresponding one of the materials 270, a temperature limit such as a maximum or minimum acceptable temperature for a corresponding one of the materials 270, or a humidity limit such as a maximum acceptable humidity for a corresponding one of the materials 270. Finally, the material safety data management module 300 transmits an alert to the operator 240 of the environmental condition exceeds one or more of the different environmental limits.

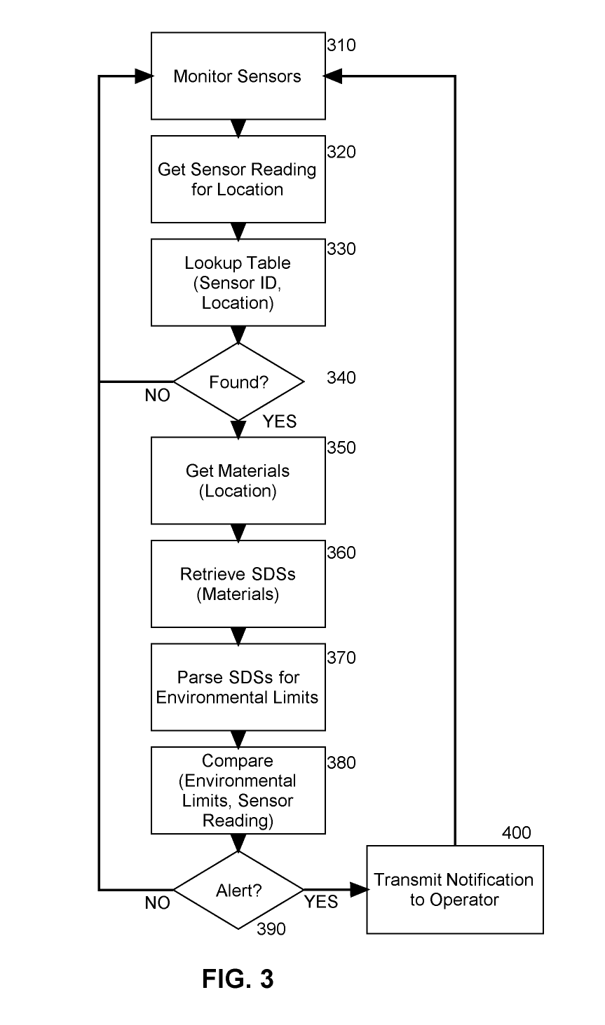

In even yet further illustration of the operation of the material safety data management module 300, FIG. 3 is a flow chart illustrating a process for automated material safety data management. Beginning in block 310, different sensors in different geographic locations are monitored. In block 320, a sensor reading is received from one of the sensors. In block 330, the identification of the sensor and the geographic location in which the sensor resides are located in a table. In decision block 340, if the combination of sensor and location are found in the table, in block 350 a listing of materials such as materials present in the location are retrieved and in block 360, a different SDS for each of the materials is loaded into memory. In block 370, each SDS is parsed to identify environmental limits such as temperature, humidity or pressure limits. In block 380, the identified environmental limits are compared to the sensor reading. In decision block 390 it is determined if the identified environmental limits have been exceeded by sensor reading. If so, in block 400 a notification is transmitted to a remote operator.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. An automated material safety data management method comprising:
creating in memory of an environmental control data processing system a listing of different materials stored in a geographic location managed by the environmental control data processing system;
querying a data store of safety data sheets and receiving in response to the querying different safety data sheets, each corresponding to a different one of the materials;
parsing each of the different safety data sheets to identify one or more environmental limits specified in one or more of the different safety data sheets;
monitoring one or more sensors disposed in the geographic location; and,
responding to an environmental condition sensed by one of the monitored sensors that exceeds one or more of the environmental limits by transmitting a notification to an operator of the environmental control data processing system.

2. The method of claim 1, wherein the data store of safety data sheets is disposed remotely from the environmental control data processing system and accessed by the environmental control data processing system from over a computer communications network.

3. The method of claim 1, wherein responding to an environmental condition sensed by one of the monitored sensors that exceeds one or more of the environmental limits comprises:
associating in memory of the environmental control data processing system selected ones of the safety data sheets with a corresponding one of the sensors; and,
detecting an environmental condition sensed by the corresponding one of the sensors;
determining if a corresponding safety data sheet is associated with the corresponding one of the sensors; and,
responding to a determination that a corresponding safety data sheet is associated with the corresponding one of the sensors by identifying an environmental limit in the corresponding safety data sheet, comparing the identified environmental limit to the sensed environmental condition, and if the identified environmental limit exceeds one or more of the environmental limits, transmitting a notification to an operator of the environmental control data processing system.

4. The method of claim 1, wherein the notification is transmitted wirelessly over the Internet to a mobile computing device of the operator.

5. The method of claim 1, wherein an acknowledgment of the notification is recorded by the operator in the environmental control data processing system.

6. An environmental control data processing system comprising:
a host computing system comprising at least one computer with memory and at least one processor;
a multiplicity of sensors disposed about a geographic location;
a monitor monitoring environmental conditions in the geographic location by way of the sensors; and,
an automated material safety data management module comprising program code executing in the memory of the host computing system, the program code when executing creating in the memory a listing of different materials stored in the geographic location, querying a data store of safety data sheets and receiving in response to the querying different safety data sheets, each corresponding to a different one of the materials, parsing each of the different safety data sheets to identify one or more environmental limits specified in one or more of the different safety data sheets and responding to an environmental condition sensed by one of the monitored sensors that exceeds one or more of the environmental limits by transmitting a notification to an operator of the environmental control data processing system.

7. The system of claim 6, wherein the data store of safety data sheets is disposed remotely from the host computing system and accessed from over a computer communications network.

8. The system of claim 6, wherein responding to an environmental condition sensed by one of the monitored sensors that exceeds one or more of the environmental limits comprises:
associating in the memory selected ones of the safety data sheets with a corresponding one of the sensors; and,
detecting an environmental condition sensed by the corresponding one of the sensors;
determining if a corresponding safety data sheet is associated with the corresponding one of the sensors; and,
responding to a determination that a corresponding safety data sheet is associated with the corresponding one of the sensors by identifying an environmental limit in the corresponding safety data sheet, comparing the identified environmental limit to the sensed environmental condition, and if the identified environmental limit exceeds one or more of the environmental limits, transmitting a notification to an operator of the environmental control data processing system.

9. The system of claim 6, wherein the notification is transmitted wirelessly over the Internet to a mobile computing device of the operator.

10. The system of claim 6, wherein an acknowledgment of the notification is recorded by the operator in the environmental control data processing system.

11. A computer program product for automated material safety data management, the computer program product comprising a computer readable storage medium having program instructions embodied therewith, the program instructions executable by a device to cause the device to perform a method comprising:
creating in memory of an environmental control data processing system a listing of different materials stored in a geographic location managed by the environmental control data processing system;
querying a data store of safety data sheets and receiving in response to the querying different safety data sheets, each corresponding to a different one of the materials;
parsing each of the different safety data sheets to identify one or more environmental limits specified in one or more of the different safety data sheets;
monitoring one or more sensors disposed in the geographic location; and,
responding to an environmental condition sensed by one of the monitored sensors that exceeds one or more of the environmental limits by transmitting a notification to an operator of the environmental control data processing system.

12. The computer program product of claim 11, wherein the data store of safety data sheets is disposed remotely from the environmental control data processing system and accessed by the environmental control data processing system from over a computer communications network.

13. The computer program product of claim 11, wherein responding to an environmental condition sensed by one of the monitored sensors that exceeds one or more of the environmental limits comprises:
associating in memory of the environmental control data processing system selected ones of the safety data sheets with a corresponding one of the sensors; and,
detecting an environmental condition sensed by the corresponding one of the sensors;
determining if a corresponding safety data sheet is associated with the corresponding one of the sensors; and,
responding to a determination that a corresponding safety data sheet is associated with the corresponding one of the sensors by identifying an environmental limit in the corresponding safety data sheet, comparing the identified environmental limit to the sensed environmental condition, and if the identified environmental limit exceeds one or more of the environmental limits, transmitting a notification to an operator of the environmental control data processing system.

14. The computer program product of claim 11, wherein the notification is transmitted wirelessly over the Internet to a mobile computing device of the operator.

15. The computer program product of claim 11, wherein an acknowledgment of the notification is recorded by the operator in the environmental control data processing system.
